(19) United States
(12) Patent Application Publication
(10) Pub. No.: US 2020/0031226 A1
(43) Pub. Date: Jan. 30, 2020

(54) ESTIMATING WHEEL SLIP OF A ROBOTIC CLEANING DEVICE

(71) Applicant: Aktiebolaget Electrolux, Stockholm (SE)

(72) Inventors: Anders Haegermarck, Trångsund (SE); Petter Forsberg, Stockholm (SE); Magnus Lindhe, Stockholm (SE); Andreas Klintemyr, Stockholm (SE)

(21) Appl. No.: 16/491,355

(22) PCT Filed: Mar. 15, 2017
(86) PCT No.: PCT/EP2017/056100

§ 371 Date: Sep. 5, 2019

(51) Int. Cl. B60K 28/16; A47L 9/28; B60W 30/18

(52) U.S. Cl. CPC B60K 28/16; A47L 2201/06; B60W 30/18172; A47L 9/2826

(57) ABSTRACT

A robotic cleaning device having a propulsion system to move the robot over a surface to be cleaned, a controller to control the propulsion system to cause the robot to perform a rotating movement, and an inertial measurement unit configured to measure a change in heading of the robotic cleaning device caused by the rotating movement. The controller is further configured to acquire signals from an odometry encoder arranged on each drive wheel of the propulsion system for measuring the change in heading of the robotic cleaning device caused by the rotating movement, and to determine a relation between the change in heading measured using odometry and the change in heading measured using the angle-measuring device, wherein a difference in the two measured changes in heading indicates an estimate of wheel slip that occurs on said surface.

### TECHNICAL FIELD

The invention relates to a robotic cleaning device and a method performed by the robotic cleaning device of determining a wheel slip characteristic of a surface over which the robotic cleaning device moves.

### BACKGROUND

In many fields of technology, it is desirable to use robots with an autonomous behaviour such that they freely can move around a space without colliding with possible obstacles.

Robotic vacuum cleaners are known in the art, which are equipped with drive means in the form of one or more motors for moving the cleaner across a surface to be cleaned. The robotic vacuum cleaners are further equipped with intelligence in the form of microprocessor(s) and navigation means for causing an autonomous behaviour such that the robotic vacuum cleaners freely can move around and clean a space in the form of e.g. a room. Thus, these prior art robotic vacuum cleaners have the capability of more or less autonomously vacuum cleaning a room in which furniture such as tables and chairs and other obstacles such as walls and stairs are located.

One example of an existing robotic vacuum cleaner detecting the type of surface it is operating on is the so called Trilobite developed by Electrolux, which uses its accelerometer or gyro to detect how bumpy the surface is, and also measures the current of the brush roll motor. The thicker the carpet it drives on, the more current the brush roll motor consumes. A problem with using the accelerometer/gyro is that it is hard to detect a difference in vibrations caused by the brush roll itself, and vibrations caused by a bumpy floor. A problem with using the brush roll current is that there are typically random variations in the current on all surfaces, so the measured current needs to be low-pass filtered, making the detection slow.

For a robotic vacuum cleaner, it is important to know which type of surface it traverses (hard floor, tiles, carpets, etc.) for two main reasons: firstly, its dust pickup capacity can be improved by adapting the fan and/or brush roll speeds to the particular type of surface it is traversing. Secondly, the wheels of the robotic cleaning device can be expected to slip more on a carpet than on e.g. a parquet floor, and this can be valuable to know for navigation purposes.

### SUMMARY

An object of the present invention is to solve, or at least mitigate this problem in the art, by providing a method performed by a robotic cleaning device of determining a wheel slip characteristic of a surface over which the robotic cleaning device moves.

This object is attained by a first aspect of the invention by a method performed by a robotic cleaning device of determining a wheel slip characteristic of a surface over which the robotic cleaning device moves. The method comprises controlling the robotic cleaning device to perform a rotating movement, measuring, using an angle-measuring device, a change in heading of the robotic cleaning device caused by the rotating movement, measuring, using odometry, the change in heading of the robotic cleaning device caused by the rotating movement, and determining a relation between the change in heading measured using odometry and the change in heading measured using the angle-measuring device, wherein a difference in the two measured changes in heading indicates an estimate of wheel slip that occurs on said surface.

This object is attained by a second aspect of the invention by a robotic cleaning device comprising a propulsion system configured to move the robotic cleaning device over a surface to be cleaned, a controller configured to control the propulsion system to cause the robotic cleaning device to perform a rotating movement, and an inertial measurement unit (IMU) configured to measure a change in heading of the robotic cleaning device caused by the rotating movement. The controller is further configured to acquire signals from an odometry encoder arranged on each drive wheel of the propulsion system for measuring the change in heading of the robotic cleaning device caused by the rotating movement, and to determine a relation between the change in heading measured using odometry and the change in heading measured using the angle-measuring device, wherein a difference in the two measured changes in heading indicates an estimate of wheel slip that occurs on said surface.

For a robotic vacuum cleaner, as previously mentioned, it is important to know which type of surface it traverses (hard floor, tiles, carpets, etc.) for a number of reasons: Firstly, its dust pickup capacity can be improved by adapting the fan and/or brush speeds to the particular type of surface it is traversing. Secondly, the wheels of the robotic cleaning device can be expected to slip more on a carpet than on e.g. a parquet floor, and this can be valuable to know for navigation purposes. Thirdly, it may be determined that a certain type of surface, e.g. a thick rug, should be traversed and cleaned not only once but perhaps twice during a cleaning programme.

In the invention, a controller of the robotic cleaning device controls wheel motors to rotate driving wheels in order to cause the robotic cleaning device to perform a rotating movement from a first position to a second position.

An angle-measuring device embodied in the form of the previously mentioned IMU, will measure a change in heading of the robotic cleaning device caused by the rotating movement.

Further, the controller acquires—from encoders arranged at each drive wheel—information in the form of generated pulses as the wheels turn. By counting the pulses at the controller, the speed of each wheel can be determined, and the controller can perform so called dead reckoning to determine position and heading of the cleaning device. This is commonly referred as odometry.

Hence, using odometry, the controller measures the change in heading of the robotic cleaning device caused by the rotating movement.

Thereafter, the controller determines a relation between the change in heading measured using odometry and the change in heading measured using the IMU. Advantageously, a difference in the two measured changes in heading gives an estimate of wheel slip that can be expected on the surface.

As a result, a wheel slip characteristic of a surface over which the robotic cleaning device moves is determined. From the determined wheel slip characteristic, conclusions can advantageously be drawn regarding the surface over which the robotic cleaning device moves.

In an embodiment, if the measured change in heading using odometry is equal to, or roughly equal to, the IMU-measured change in heading, the controller of the robotic cleaning device concludes that there is no or little wheel slip, which is oftentimes the case when the robotic device moves over an even, hard surface, such as a parquet floor, hard floor, concrete floor, etc.

In another embodiment, if the measured change in heading using odometry moderately or greatly differs from the IMU-measured change in heading, the controller of the robotic cleaning device concludes that the surface indeed causes the wheels to slip, and typically constitutes a textile surface such as a carpet or a rug.

In still an embodiment, the rotational movement caused by the controller controlling the wheel motors to rotate the driving wheels should result in a rotational angle exceeding an angle threshold value such as 45° or 90°, or possibly even 180°, or 360° to ensure that an adequate slip estimate can be attained. Hence, if a too small rotation is performed, it may not be possible for the controller to adequately determined whether there is wheel slip or not, in particular if the slip is scant.

In yet an embodiment, during the rotational movement, a plurality of values reflecting the change in heading should be measured by the IMU, and a plurality of values reflecting the change in heading should be measured by the controller using odometry.

Thus, by performing a plurality of measurements during the rotational movement, a relation over time between the IMUe-measurement and the odometry-measurement can be determined.

For instance, if the relation is defined as a relation between rotating angles Δθ_{IMU} measured by the IMU and rotating angles Δθ_{odo} measured using odometry, a number of scenarios can be envisaged

In a first scenario, if the relation between Δθ_{IMU} and Δθ_{odo} is linear and 1:1 (or at least close to), no slip has occurred, typically implying a hard and smooth surface as previously discussed.

In a second scenario, if the relation between Δθ_{IMU} and Δθ_{odo} is linear but not 1:1, a uniform slip has occurred, typically implying a uniform slip with no distinct direction thereby indicating that the robotic device passes over a textile surface.

In a third scenario, if the relation between Δθ_{IMU} and Δθ_{odo} is monotonously increasing according to an S-shape, a directional slip has occurred, typically implying that the slip varies with the rotational angle and/or direction of rotation.

In a fourth scenario, if the relation between Δθ_{IMU} and Δθ_{odo} is at least partly discontinuous, this indicates sections of uneven slip, typically implying at least a partly uneven surface.

Further provided is a computer program comprising computer-executable instructions for causing the robotic cleaning device to perform the method according to embodiments of the invention when the computer-executable instructions are executed on the controller included in the robotic cleaning device.

Yet further provided is a computer program product comprising a computer readable medium, the computer readable medium having the above mentioned computer program embodied thereon.

Further embodiments of the invention will be discussed in the detailed description.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The invention is now described, by way of example, with reference to the accompanying drawings, in which:

FIG. 1 shows a robotic cleaning device according to an embodiment of the present invention;

FIG. 2 illustrates a robotic cleaning device according to an embodiment moving from a first type of surface to a second type of surface;

FIG. 3 illustrates a flowchart of a method performed by a robotic cleaning device of determining a wheel slip characteristic of a surface according to an embodiment;

FIG. 4 illustrates how a robotic cleaning device is controlled to move for determining the wheel slip characteristic of the underlying surface according to an embodiment; and

FIGS. 5(a)-(d) illustrate four different types of wheel slip detected using the method of the invention.

### DETAILED DESCRIPTION

The invention will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout the description.

The invention relates to robotic cleaning devices, or in other words, to automatic, self-propelled machines for cleaning a surface, e.g. a robotic vacuum cleaner, a robotic sweeper or a robotic floor washer. The robotic cleaning device according to the invention can be mains-operated and have a cord, be battery-operated or use any other kind of suitable energy source, for example solar energy.

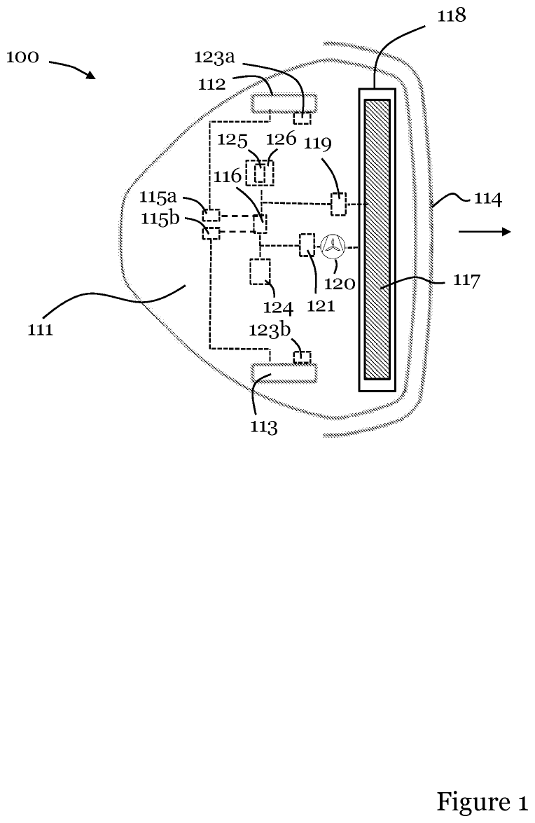

Even though it is envisaged that the invention may be performed by any appropriate robotic cleaning device being equipped with sufficient processing intelligence, FIG. 1 shows a robotic cleaning device 100 according to an embodiment of the present invention in a bottom view, i.e. the bottom side of the robotic cleaning device is shown. The arrow indicates the forward direction of the robotic cleaning device 100 being illustrated in the form of a robotic vacuum cleaner.

The robotic cleaning device 10o comprises a main body 111 housing components such as a propulsion system comprising driving means in the form of two electric wheel motors 115a, 115b for enabling movement of the driving wheels 112, 113 such that the cleaning device can be moved over a surface to be cleaned. Each wheel motor 115a, 115b is capable of controlling the respective driving wheel 112, 113 to rotate independently of each other in order to move the robotic cleaning device 10o across the surface to be cleaned. A number of different driving wheel arrangements, as well as various wheel motor arrangements, can be envisaged. It should be noted that the robotic cleaning device may have any appropriate shape, such as a device having a more traditional circular-shaped main body, or a triangular-shaped main body. As an alternative, a track propulsion system may be used or even a hovercraft propulsion system. The propulsion system may further be arranged to cause the robotic cleaning device 100 to perform any one or more of a yaw, pitch, translation or roll movement.

A controller 116 such as a microprocessor controls the wheel motors 115a, 115b to rotate the driving wheels 112, 113 as required in view of information received from an obstacle detecting device for detecting obstacles in the form of walls, floor lamps, table legs, around which the robotic cleaning device must navigate.

In the exemplifying embodiment of FIG. 1, the obstacle detecting device is implemented in the form of a bumper 114. For illustrative purposes, the distance between the bumper 114 and a front end portion of the main body 111 is somewhat exaggerated; in practice the bumper 119 is arranged flush against the front end portion.

When the robotic cleaning device 10o moves forward and bumps into an obstacle, contact with the obstacle is detected by the bumper 114, which is flexibly mounted to the front end portion of the main body 111. Since the bumper 114 is flexible, it will press resiliently against the front end portion of the body in when contacting obstacles, thus mitigating the thrusting effect it has on obstacles in its way and reducing the risk that the obstacles will be displaced, tipped over and/or be damaged.

The microprocessor 116 registers pressing of the bumper 114 against the main body 111 and hence detects contact with an obstacle, in order to control the motors 115a, 115b to rotate the driving wheels 112, 113 thereby controlling movement of the robotic cleaning device limas required accordingly.

It is noted that other more complex obstacle detecting devices are envisaged, such as infrared (IR) sensors and/or sonar sensors, microwave radar, or even a vision based sensor system in the form of a 3D sensor system registering its surroundings, implemented by means of e.g. a 3D camera, a camera in combination with lasers, a laser scanner, etc. for detecting obstacles and communicating information about any detected obstacle to the microprocessor 116. The microprocessor 116 communicates with the wheel motors 115a, 1151D to control movement of the wheels 112, 113 in accordance with information provided by the obstacle detecting device such that the robotic cleaning device 100 can move as desired across the surface to be cleaned. A combination of various obstacle detecting devices is further envisaged.

Further, the main body 111 may optionally be arranged with a cleaning member 117 for removing debris and dust from the surface to be cleaned in the form of a rotatable brush roll arranged in an opening 118 at the bottom of the robotic cleaner 100. Thus, the rotatable brush roll 117 is arranged along a horizontal axis in the opening 118 to enhance the dust and debris collecting properties of the cleaning device 100. In order to rotate the brush roll 117, a brush roll motor 119 is operatively coupled to the brush roll to control its rotation in line with instructions received from the controller 116.

Moreover, the main body in of the robotic cleaner 100 comprises a suction fan 120 creating an air flow for transporting debris to a dust compartment, a dust bag or cyclone arrangement (not shown) housed in the main body via the opening 118 in the bottom side of the main body 111. The suction fan 120 is driven by a fan motor 121 communicatively connected to the controller 116 from which the fan motor 121 receives instructions for controlling the suction fan 120. It should be noted that a robotic cleaning device having either one of the rotatable brush roll 117 and the suction fan 120 for transporting debris to the dust bag can be envisaged. A combination of the two will however enhance the debris-removing capabilities of the robotic cleaning device 100.

The robotic cleaning device 100 may further be arranged with one or more side brushes (not shown) for further improving the removal of dust and debris from the surface over which the robotic cleaning device 100 moves.

The main body 111 or the robotic cleaning device 100 may further be equipped with an inertial measurement unit (IMU) 124, such as e.g. a gyroscope and/or an accelerometer and/or a magnetometer and/or a compass or any other appropriate device for measuring displacement of the robotic cleaning device 100 with respect to a reference position, in the form of e.g. orientation, rotational velocity, gravitational forces, etc. The robotic cleaning device 100 further comprise encoders 123a, 123b on each drive wheel 112, 113 which generate pulses when the wheels turn. The encoders may for instance be magnetic or optical. By counting the pulses at the controller 116, the speed of each wheel 112, 113 can be determined, and the controller 116 can perform so called dead reckoning to determine position and heading of the cleaning device 100.

With further reference to FIG. 1, the controller/processing unit 116 embodied in the form of one or more microprocessors is arranged to execute a computer program 125 downloaded to a suitable storage medium 126 associated with the microprocessor, such as a Random Access Memory (RAM), a Flash memory or a hard disk drive. The controller 116 is arranged to carry out a method according to embodiments of the present invention when the appropriate computer program 125 comprising computer-executable instructions is downloaded to the storage medium 126 and executed by the controller 116. The storage medium 126 may also be a computer program product comprising the computer program 125. Alternatively, the computer program 125 may be transferred to the storage medium 126 by means of a suitable computer program product, such as a digital versatile disc (DVD), compact disc (CD) or a memory stick. As a further alternative, the computer program 125 may be downloaded to the storage medium 126 over a wired or wireless network. The controller 116 may alternatively be embodied in the form of a digital signal processor (DSP), an application specific integrated circuit (ASIC), a field-programmable gate array (FPGA), a complex programmable logic device (CPLD), etc.

For a robotic vacuum cleaner, as previously mentioned, it is important to know which type of surface it traverses (hard floor, tiles, carpets, etc.) for a number of reasons: Firstly, its dust pickup capacity can be improved by adapting the fan and/or brush speeds to the particular type of surface it is traversing. Secondly, the wheels of the robotic cleaning device can be expected to slip more on a carpet than on e.g. a parquet floor, and this can be valuable to know for navigation purposes. Thirdly, it may be determined that a certain type of surface, e.g. a thick rug, should be traversed and cleaned not only once but perhaps twice during a cleaning programme.

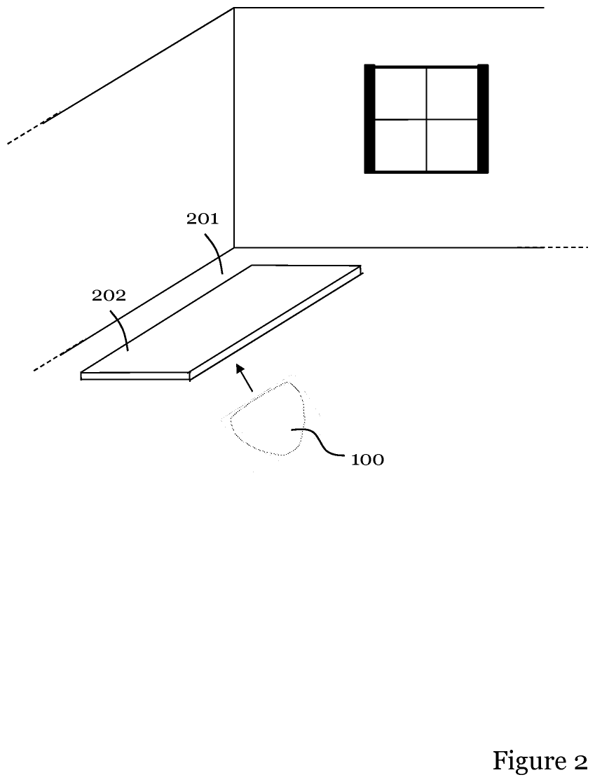

FIG. 2 illustrates a robotic cleaning device 100 according to an embodiment of the present invention moving from a first surface 201, such as a hard floor, to a second surface 202, such as a thick carpet in the form of for instance a rug.

As discussed, it is useful to know on which type of surface the robotic cleaning devices 100 moves.

Now, the risk for the robotic device 100 of being subjected to wheel slip is substantially higher when moving over the rug 202 as compared to moving over the hard floor 201.

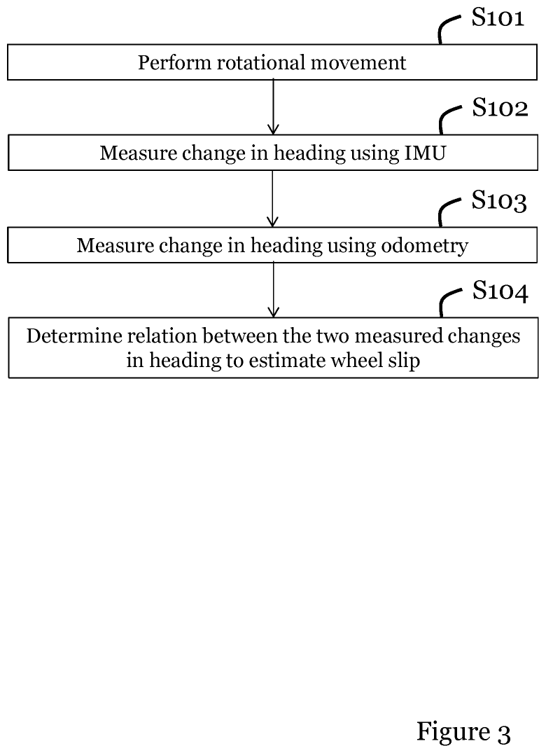

FIG. 3 illustrates a flowchart of a method performed by the robotic cleaning device 100 of determining a wheel slip characteristic of a surface over which the robotic cleaning device moves. From the determined wheel slip characteristic, conclusions can be drawn regarding the surface over which the robotic cleaning device 100 moves.

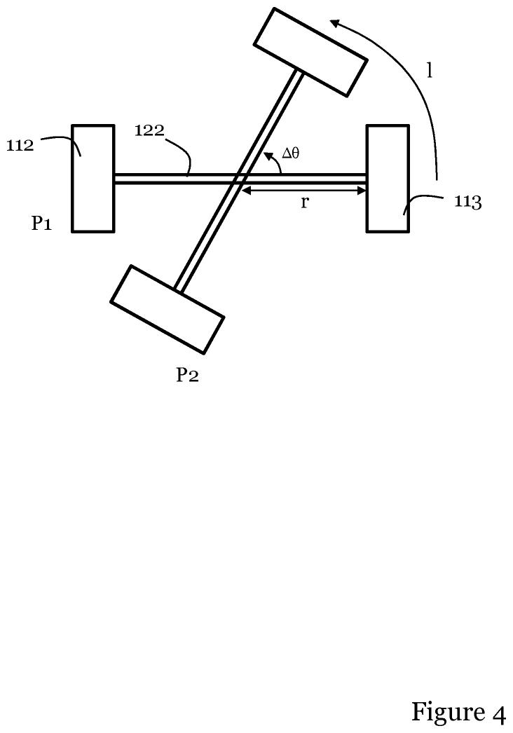

Reference is further made to FIG. 4, which illustrates how the robotic cleaning device is controlled to move for determining the wheel slip characteristic of the underlying surface according to an embodiment. Hence, the robotic cleaning device 100—illustrated only in FIG. 4 by means of driving wheels 112, 113 and wheel shaft 122—is rotated from a first position P1 to a second position P2.

The radius of the wheel shaft 122 is denoted r, while the angle of rotation is denoted Δθ and the rotational distance, i.e. arc length, is denoted 1.

Reference is further made to FIG. 1 for a description of the various components included in the robotic device 100.

Hence, in a first step S101, the controller 116 controls the wheel motors 115a, 115b to rotate the driving wheels 112, 113 in order to cause the robotic cleaning device to move from the first position P1 to the second position P2.

An angle-measuring device embodied in the form of the previously mentioned IMU 124, being e.g. a gyroscope, accelerometer, magnetometer, a compass, or a combination thereof, will in step S102 measure a change in heading of the robotic cleaning device 100 caused by the rotating movement.

Further, the controller 116 acquires from the encoders 123a, 123b arranged at each drive wheel 112, 113 information in the form of pulses generated by the encoders as the wheels turn. By counting the pulses at the controller 116, the speed of each wheel 112, 113 can be determined, and the controller 116 can perform so called dead reckoning to determine position and heading of the cleaning device 100. This is commonly referred as odometry.

Hence, using odometry, the controller 116 measures in step 103—in cooperation with the encoders 123a, 123b—the change in heading of the robotic cleaning device 100 caused by the rotating movement.

It is noted that the steps S102 and S103 may be performed simultaneously or in a reversed order.

Now, in step S104, the controller 116 determines a relation between the change in heading measured using odometry and the change in heading measured using the IMU 124, wherein a difference in the two measured changes in heading gives an estimate of wheel slip that can be expected on the surface.

In an embodiment, the change in heading is determined as follows.

With reference to FIG. 4, the rotational angle Δθ as measured by the IMU 124 is denoted Δθ_{IMU} which for instance can be determined by having a gyroscope measure angular velocity during the rotational movement of the robotic device 10o and then have the controller 116 perform an integration of the measured angular velocity.

The rotational angle Δθ as measured using odometry is denoted Δθ_{odo} and is measured as:

$${Δθ}_{odo} = \frac{{l}_{odo}}{r}$$

Hence, the (fixed) distance from an axis of rotation of the robotic cleaning device 100 to a point at one of the wheels 112 is determined, and then the distance of movement of the wheel 112 from the first position P1 to the second position P2 is measured, wherein the rotating angle Δθ_{odo} measured using odometry is measured as a ratio between the measured distance of movement of the wheel 112 and the determined distance from the wheel 112 to the axis of rotation.

A relation between the change in heading measured using odometry and the change in heading measured using the IMU can be determined as:

$$ɛ = \frac{\vert {l}_{IMU} - {l}_{odo} \vert}{\vert {l}_{odo} \vert}$$

wherein a difference in the two measured changes in heading gives an estimate of wheel slip that can be expected on the surface.

For instance, if there is no or little wheel slip, which is oftentimes the case when the robotic device 100 moves over an even, hard surface, such as a parquet floor, hard floor, concrete floor, etc., the travelled distance l_{odo} as measured using odometry will be equal, or roughly equal, to the actually travelled distance l_{IMU} as measured by the IMU 124 and as a consequence ε=0 (or very close to zero).

To the contrary, if substantial wheel slip occurs during the rotational movement, the travelled distance loan as measured using odometry will due to the slipping be greater (or even much greater than) the actually travelled distance l_{IMU} as measured by the IMU 124 and as a consequence ε>0.

In an embodiment, the relation c between the change in heading measured using odometry and the change in heading measured using the IMU is compared to a predetermined threshold value T, and if ε≥T the controller 116 concludes that wheel slip has occurred.

If ε≥T, the controller 116 may conclude that the surface over which the robotic device 100 moves is a textile surface, which advantageously may imply that the dust pickup capacity should be improved by increasing the fan and/or brush roll speeds, or by having the robotic device 100 traverse the textile more than once.

It may further advantageously imply that the wheel slip should be compensated for in a navigation algorithm executed by the controller 116.

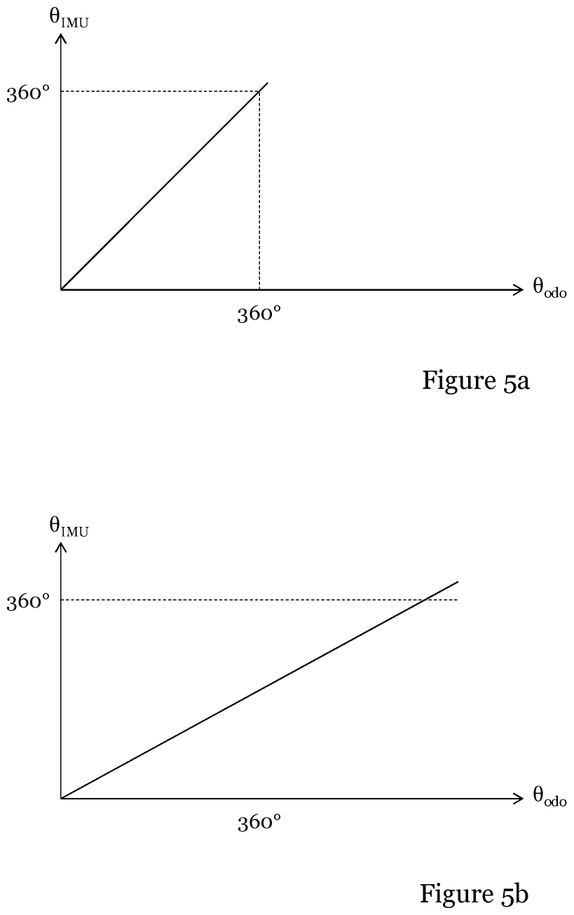

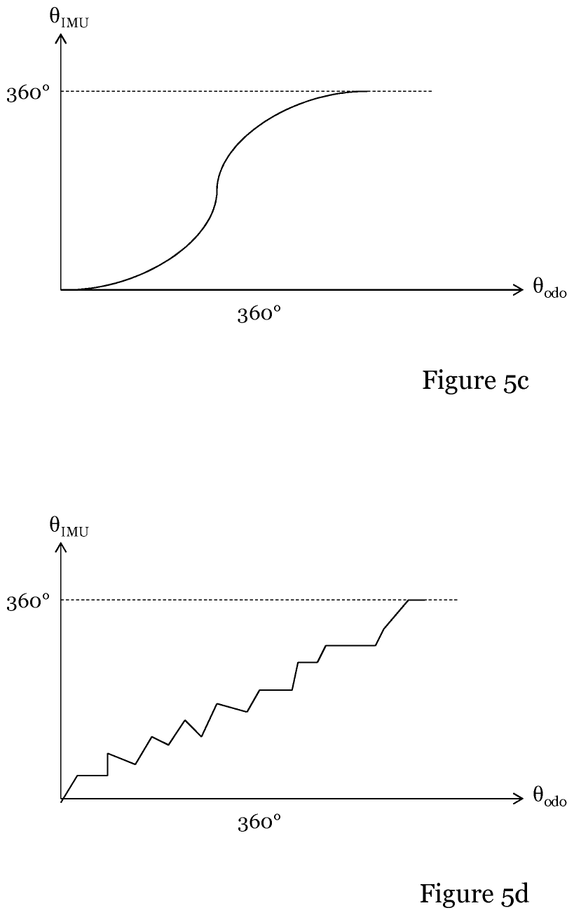

FIGS. 5(a)-(d) illustrate four different types of wheel slip detected using the method of the invention, where the relation between the two measured changes in heading is given by the respective measured rotating angle Δθ_{IMU} and Δθ_{odo}.

In an embodiment, the rotational movement caused by the controller 116 controlling the wheel motors 115a, 115b to rotate the driving wheels 112, 113 should result in a rotational angle Δθ exceeding an angle threshold value such as 45° or 90°, or possibly even 180°, or 360° to ensure that an adequate slip estimate can be attained. FIGS. 5(a)-(d) show a full rotation of the robotic device 100.

In a further embodiment, during the rotational movement, a plurality of values reflecting the change in heading should be measured by the IMU 124, and a plurality of values reflecting the change in heading should be measured using odometry.

Thus, by performing a plurality of measurements during the rotational movement, a relation over time between the angle-measurement and the odometry-measurement can be determined.

With reference to FIG. 5(a), if the relation between Δθ_{IMU} and Δθ_{odo} is linear and 1:1 (or at least close to), no slip has occurred, typically implying a hard and smooth surface as previously discussed.

With reference to FIG. 5(b), if the relation between Δθ_{IMU} and Δθ_{odo} is linear but not ti, a uniform slip has occurred, typically implying a uniform slip with no distinct direction thereby indicating that the robotic device passes over a textile surface.

With reference to FIG. 5(c), if the relation between Δθ_{IMU} and Δθ_{odo} is monotonously increasing according to an S-shape, a directional slip has occurred, typically implying that the slip varies with the rotational angle and/or direction of rotation. For instance, assuming that the robotic device rotates 360°, a first slip characteristic may be experienced during the first 180° while a second slip characteristic may be experienced during the remaining 180°. Hence, different navigational compensation may be required depending on driving direction.

With reference to FIG. 5(d), the relation between Δθ_{IMU} and Δθ_{odo} is at least partly discontinuous, which indicates sections of uneven slip, typically implying at least a partly uneven surface.

The invention has mainly been described above with reference to a few embodiments. However, as is readily appreciated by a person skilled in the art, other embodiments than the ones disclosed above are equally possible within the scope of the invention, as defined by the appended patent claims.

1. A method, performed by a robotic cleaning device, of determining a wheel slip characteristic of a surface over which the robotic cleaning device moves, the method comprising:
controlling the robotic cleaning device to perform a rotating movement;
measuring, using an angle-measuring device, a first measured change in heading of the robotic cleaning device caused by the rotating movement;
measuring, using odometry, a second measured change in heading of the robotic cleaning device caused by the rotating movement;
determining a relation between the first measured change in heading and the second measured change in heading; and
determining an estimate of wheel slip that occurs on said surface based on a difference between the first measured change in heading and the second measured change in heading.

2. The method of claim 1, wherein the measuring of the first measured change in heading and the second measured change in heading of the robotic cleaning device caused by the rotating movement comprises measuring a first rotating angle using the angle-measuring device and measuring a second rotating angle using odometry caused by the rotating movement.

3. The method of claim 1, wherein the measuring of the first measured change in heading and the second measured change in heading of the robotic cleaning device caused by the rotating movement comprises measuring a first travelled distance using the angle-measuring device and measuring a second travelled distance using odometry caused by the rotating movement.

4. The method of claim 1, wherein upon determining a small or no difference between the first measured change in heading and the second measured change in heading, the determination of wheel slip comprises determining a low degree of slip or no slip.

5. The method of claim 1, wherein
upon determining a moderate or great difference between the first measured change in heading and the second measured change in heading, the determination of wheel slip comprises determining moderate or great slip.

6. The method of claim 1, wherein the rotating movement is controlled to exceed an angle threshold value in order to ensure an adequate wheel slip estimate.

7. The method of claim 1, wherein:
measuring the first measured change in heading of the robotic cleaning device caused by the rotating movement comprises measuring, using the angle-measuring device, a first plurality of values of a first property reflecting the change in heading as the robotic cleaning device performs the rotating movement;
measuring the second measured change in heading of the robotic cleaning device caused by the rotating movement comprises measuring, using odometry, a second plurality of values of a second property reflecting the change in heading as the robotic cleaning device performs the rotating movement; and
determining the relation between the first measured change in heading and the second measured change in heading comprises comparing the first plurality of values of the first property to the second plurality of values of the second property.

8. The method of claim 7, wherein upon determining that the first plurality of values of the first property and the second plurality of values of the second property have a relation that is linear and 1:1, or close to linear and 1:1, determining that no slip has occurred and the surface comprises a hard and smooth surface.

9. The method of claim 7, wherein upon determining that the first plurality of values of the first property and the second plurality of values of the second property have a relation that is linear but not 1:1, or close to linear but not 1:1, determining that a uniform slip has occurred and the surface comprises a textile surface.

10. The method of claim 7, wherein upon determining that the first plurality of values of the first property and the second plurality of values of the second property have a relation that is monotonously increasing and S-shaped, determining that a directional slip has occurred and the surface comprises a textile surface.

11. The method of claim 7, wherein upon determining that the first plurality of values of the first property and the second plurality of values of the second property have a relation that is at least partly discontinuous, determining that an uneven slip has occurred and the surface comprises an at least a partly uneven surface.

12. A robotic cleaning device comprising:
a propulsion system configured to move the robotic cleaning device over a surface to be cleaned;
a controller configured to control the propulsion system to cause the robotic cleaning device to perform a rotating movement;
an inertial measurement unit configured to measure a first change in heading of the robotic cleaning device caused by the rotating movement;
the controller further being configured to:
acquire signals from an odometry encoder arranged on each drive wheel of the propulsion system for measuring a second change in heading of the robotic cleaning device caused by the rotating movement,
determine a relation between the first change in heading measured using odometry and the second change in heading measured using the angle-measuring device, and
determine an estimate of wheel slip that occurs on said surface based on a difference between the first change in heading and the second change in heading.

13. The robotic cleaning device of claim 12, wherein:
the inertial measurement unit is configured to measure the first change in heading by measuring a rotating angle of the robotic cleaning device caused by the rotating movement; and
the controller is configured to measure the second change in heading by measuring a rotating angle of the robotic cleaning device caused by the rotating movement using odometry.

14. The robotic cleaning device of claim 12, wherein:
the inertial measurement unit is configured to measure the first change in heading by measuring a first travelled distance of the robotic cleaning device caused by the rotating movement; and
the controller is configured to measure the second change in heading by measuring a second travelled distance of the robotic cleaning device caused by the rotating movement using odometry.

15. The robotic cleaning device of claim 12, wherein the controller is configured, upon determining a small or no difference between the first measured change in heading and the second measured change in heading, to determine that the estimate of wheel slip is a low degree of slip or no slip.

16. The robotic cleaning device of claim 12, wherein the controller is configured, upon determining a moderate or great difference between the first measured change in heading and the second measured change in heading, to determine that the estimate or wheel slip is moderate or great slip.

17. The robotic cleaning device of claim 12, wherein the controller is configured to control the rotating movement to exceed an angle threshold value in order to ensure an adequate wheel slip estimate.

18. The robotic cleaning device of claim 12, wherein:
the first change in heading comprises a first plurality of values of a first property reflecting the change in heading as the robotic cleaning device performs the rotating movement;
the second change in heading comprises a second plurality of values of a second property reflecting the change in heading as the robotic cleaning device performs the rotating movements,
and the controller is configured to determine the relation between the first measured change in heading and the second measured change in heading by comparing the first plurality of values of the first property to the second plurality of values of the second property.

19. The robotic cleaning device of claim 18, wherein upon determining that the first plurality of values of the first property and the second plurality of values of the second property have a relation that is linear and 1:1, or close to linear and 1:1, the controller is configured to determine that no slip has occurred and the surface comprises a hard and smooth surface.

20. The robotic cleaning device of claim 18, wherein upon determining that the first plurality of values of the first property and the second plurality of values of the second property have a relation that is linear but not 1:1, or close to linear but not 1:1, the controller is configured to determine that a uniform slip has occurred and the surface comprises a textile surface.

21. The robotic cleaning device of claim 18, wherein upon determining that the first plurality of values of the first property and the second plurality of values of the second property have a in case said relation is monotonously increasing and S-shaped, the controller is configured to determine that a directional slip has occurred and the surface comprises a textile surface.

22. The robotic cleaning device of claim 18, wherein upon determining that the first plurality of values of the first property and the second plurality of values of the second property have a in case said relation is at least partly discontinuous, the controller is configured to determine that uneven slip has occurred and the surface comprises at least a partly uneven surface.

23. A computer program comprising computer-executable instructions for causing a robotic cleaning device to perform the steps recited in claim 1 when the computer-executable instructions are executed on a controller included in the robotic cleaning device.

24. A computer program product comprising a computer readable medium, the computer readable medium having the computer program according to claim 23 embodied thereon.
